(19) United States
(12) Patent Application Publication
(10) Pub. No.: US 2016/0105326 A1
(43) Pub. Date: Apr. 14, 2016

(54) AIRCRAFT COMMUNICATIONS NETWORK WITH DISTRIBUTED RESPONSIBILITY FOR COMPATIBILITY CONFIRMATION

(71) Applicant: Gulfstream Aerospace Corporation, Savannah, GA (US)

(72) Inventor: Derek Smart, Savannah, GA (US)

(21) Appl. No.: 14/881,600

(22) Filed: Oct. 13, 2015

Related U.S. Application Data
(60) Provisional application No. 62/063,226, filed on Oct. 13, 2014.

(51) Int. Cl. H04L 12/24

(52) U.S. Cl. CPC H04L 41/12; H04L 41/0869

(57) ABSTRACT

Aircraft communications networks, network devices, and methods of determining compatibility on an aircraft communications network are disclosed herein. The aircraft communications network includes, but is not limited to, a communications bus, a first network device, and a second network device. The first network device is communicatively coupled with the communications bus and is configured to publish on the communications bus a configuration manifest that describes a compatible configuration of hardware and software for the aircraft communications network. The second network device is communicatively coupled with the communications bus and is configured to receive the configuration manifest from the first network device over the communications bus, compare the configuration manifest to a second hardware and software profile that describes the second network device, and disable outputs of the second network device in response to detecting that the configuration manifest differs from the second hardware and software profile.

### CROSS-REFERENCE TO RELATED APPLICATIONS

This application claims the benefit of U.S. Provisional Application No. 62/063,226 filed on Oct. 13, 2014. The disclosure of the above application is incorporated herein by reference.

### TECHNICAL FIELD

The present invention generally relates to aircraft communications networks, and more particularly relates aircraft communications networks with components that confirm their own compatibility with a network based on a configuration manifest that is distributed on the network.

### BACKGROUND

A modern passenger aircraft commonly includes a computer data network by which various aircraft components communicate. The compatibility of each component on the network is typically checked upon powering up the network to confirm that the correct components are installed. Conventional aircraft communications networks typically check this compatibility using a centralized controller that receives information relating to the hardware and software of each component. When the information does not match what the centralized controller expects, the centralized controller determines that the component is not compatible.

While such conventional communications networks are adequate, there is room for improvement. Accordingly, it is desirable to provide a communications network that confirms compatibility of components without the burdens associated with a centralized controller. Furthermore, other desirable features and characteristics will become apparent from the subsequent detailed description and the appended claims, taken in conjunction with the accompanying drawings and the foregoing technical field and background.

### BRIEF SUMMARY

Aircraft communications networks, network devices, and methods of determining compatibility on an aircraft communications network are disclosed herein.

In a first non-limiting embodiment, an aircraft communications network includes, but is not limited to, a communications bus, a first network device, and a second network device. The first network device is communicatively coupled with the communications bus and is configured to publish on the communications bus a configuration manifest that describes a compatible configuration of hardware and software for the aircraft communications network. The second network device is communicatively coupled with the communications bus and is configured to receive the configuration manifest from the first network device over the communications bus, compare the configuration manifest to a second hardware and software profile that describes the second network device, and disable outputs of the second network device in response to detecting that the configuration manifest differs from the second hardware and software profile.

In a second non-limiting embodiment, a network device for an aircraft communications network includes, but is not limited to, a computer hardware component and a software component. The computer hardware component includes an input/output (I/O) portion configured for connecting to an aircraft communications bus and the software component is loaded into the computer hardware component. The computer hardware component and the software component cooperate to configure the network device to receive a configuration manifest through the I/O portion, compare the configuration manifest to a hardware and software profile that describes the computer hardware component and the software component, and disable outputs from the network device through the I/O portion in response to detecting that the configuration manifest differs from the hardware and software profile.

In a third non-limiting embodiment, a method of determining compatibility of a network device with an aircraft communications network includes, but is not limited to, publishing on a communications network, by a first network device, a configuration manifest that describes a compatible configuration of hardware and software for the aircraft communications network. The method further includes receiving, at a second network device, the configuration manifest. The method yet further includes comparing, at the second network device, the configuration manifest to a second hardware and software profile that describes the second network device.

### BRIEF DESCRIPTION OF THE DRAWINGS

The present invention will hereinafter be described in conjunction with the following drawing figures, wherein like numerals denote like elements, and

FIG. 1 is a block schematic diagram illustrating a non-limiting embodiments of a data concentration network of an aircraft in accordance with the teachings of the present disclosure;

FIG. 2 is a table showing the data allocation of a configuration manifest used in the data concentration network according to the teachings of the present disclosure;

FIG. 3 is a flow diagram showing operability of various functions running on components of the network according to the teachings of the present disclosure; and

FIG. 4 is a flow diagram illustrating a non-limiting embodiment of a method for determining compatibility of network devices in the data concentration network of FIG. 1 in accordance with the teachings of the present disclosure.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An improved aircraft communications network is disclosed herein. As compared with conventional aircraft communications networks, the aircraft communications network of the present disclosure includes network devices that confirm their own compatibility with the network based on a distributed compatibility manifest. One or more of the network devices may publish or distribute the configuration manifest on a communications bus for receipt by the other network devices. Each network device compares a hardware and software profile of itself to the received configuration manifest. When the comparison reveals a mismatch or difference, the network device may generate an alert that the network device is incompatible with the aircraft communications network.

A greater understanding of the aircraft communications network and components described above may be obtained through a review of the illustrations accompanying this application together with a review of the detailed description that follows.

Referring to the Figures, wherein like numerals indicate like parts throughout the several views, a data concentration network (“DCN”) 100 for an aircraft (not numbered) is shown and described herein. A method for determining configuration compatibility across the DCN 100 is also shown and described herein.

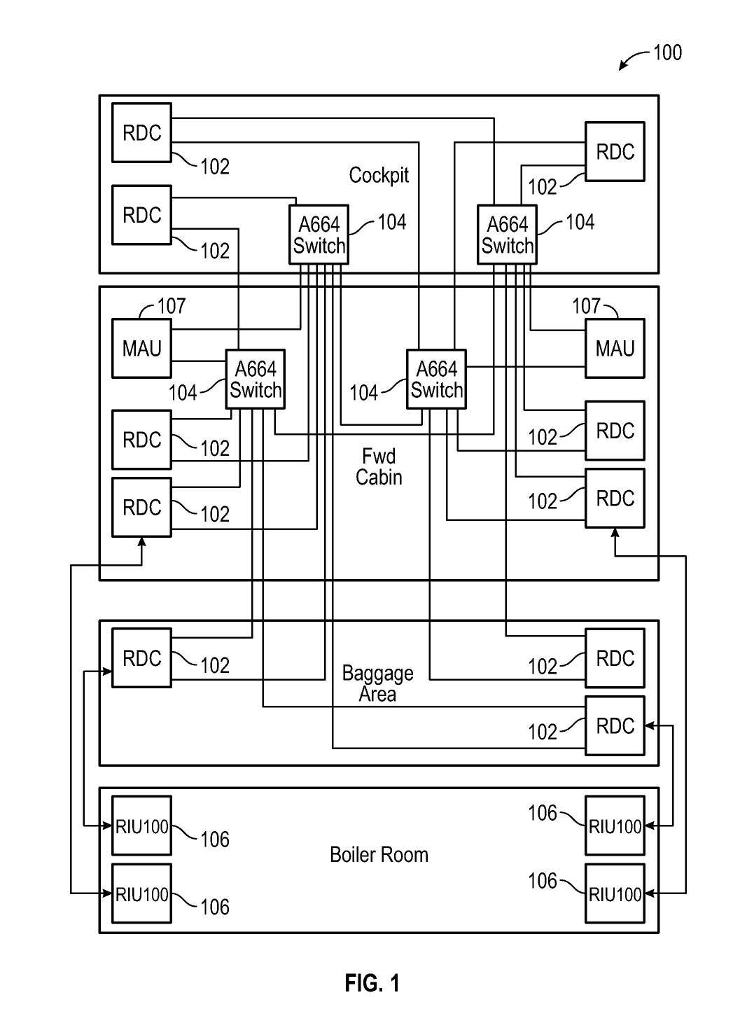

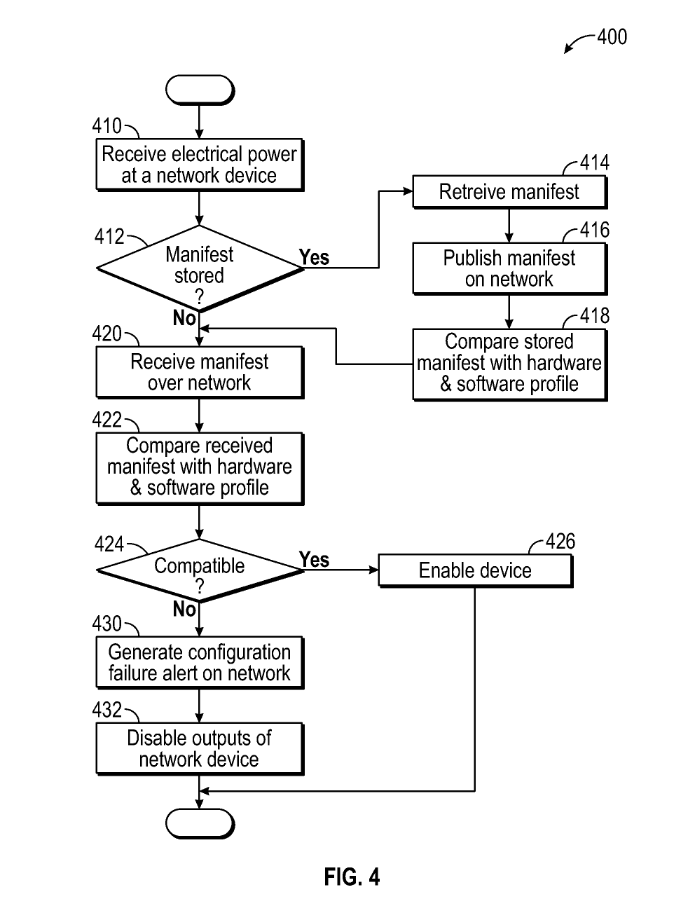

The DCN 100 is shown in FIG. 1. In the exemplary embodiment, the DCN is an Ethernet-based network of various network devices coupled for communication with an aircraft communications bus at an input/output portion (I/O portion) configured to send and receive signals on DCN 100. In the example provided, the aircraft communications bus includes a plurality of current carrying wires. It should be appreciated that other physical mediums that carry communications signals (such as fiber optic networks or wireless networks) may be utilized as the aircraft communications bus without departing from the scope of the present disclosure. The network devices may include any control circuitry capable of performing the various tasks described below with reference to FIG. 4. For example, the network devices may include an application specific integrated circuit (ASIC), an electronic circuit, a processor (shared, dedicated, or group) and memory that execute one or more software or firmware programs, a combinational logic circuit, and/or other suitable components that provide the described functionality. In some embodiments, the network devices may include hardware-based logic, or may include a combination of hardware, firmware, and/or software elements.

The DCN 100 includes a plurality of remote data concentrators (“RDCs”) 102. The RDCs are configured to consolidate inputs from the systems and/or sensors of the aircraft and distribute them across the DCN 100. Each RDC 102 may be in communication with at least one line-replaceable unit (“LRU”) (not shown) across a communications bus. As appreciated by those skilled in the art, an LRU is a modular component of the aircraft that may be interchanged, i.e., removed and replaced with a different component. For example, each LRU may be an avionics device, such as a flight control computer, an inertial reference unit, a traffic collision avoidance system, a health and trend monitoring unit, or the like.

The DCN 100 further includes at least one ARINC 664 switch 104 (“A664 switch”). The A664 switch 104 conforms with the ARINC 664 Ethernet network standard developed by Aeronautical Radio, Incorporated (“ARINC”). Each A664 switch is in communication with at least one RDC 102. Each A664 switch 104 routes communications between the various components of DCN 100.

The DCN 100 also includes at least one remote interface unit (“RIU”) 106. In the exemplary embodiment, each RIU 106 is in communication with one of the RDCs 102. The RIUs 106 do not communicate directly with the A664 switches 104.

The DCN 100 of the exemplary embodiment further includes at least one modular avionics unit (“MAU”) 107. The MAU 107 is a computer system for avionics and crew display functions. These functions include, but are not limited to flight management, crew alerting, and informational displays. In the example provided, MAU 107 includes various LRUs in a single physical location on the aircraft. It should be appreciated that MAU 107 may instead be distributed throughout the aircraft without departing from the scope of the present disclosure. As will be appreciated by those with ordinary skill in the art, RDCs 102, LRUs, switches 104, RIUs 106, and MAU 107 are network devices that may perform the operations of the method described below and illustrated in FIG. 4.

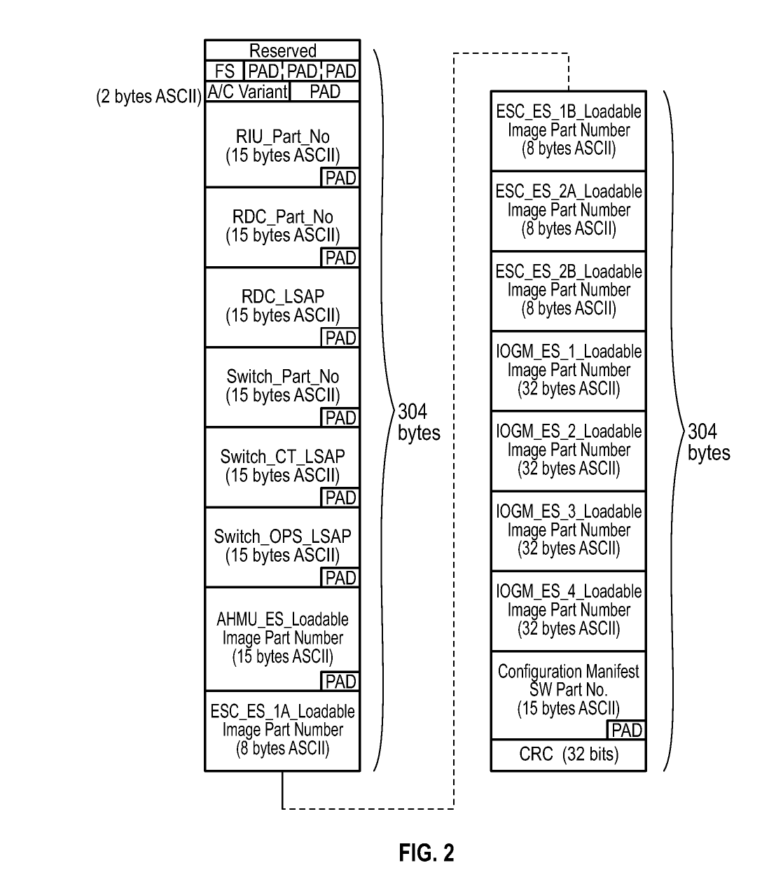

FIG. 2 illustrates an exemplary configuration manifest 200. The configuration manifest 200 is pre-defined for the particular aircraft and identifies the part numbers of the components of the DCN 100, such as the RDCs 102, the A664 switches 104, and the RIUs 106, that are compatible with the DCN 100. The configuration manifest also includes all aircraft LRUs that interface to the A664 switches 104. In this exemplary embodiment, that includes an electrical system controller (“ESC”), a MAU input/output gateway module (“IOGM”) and an aircraft health and trend monitoring system.

The configuration manifest 200 is initially stored on at least one of the RDCs 102. Specifically, in the exemplary embodiment, the configuration manifest 200 is stored on RDCs 102 that are electrically connected to a ground bus (not shown) of the aircraft.

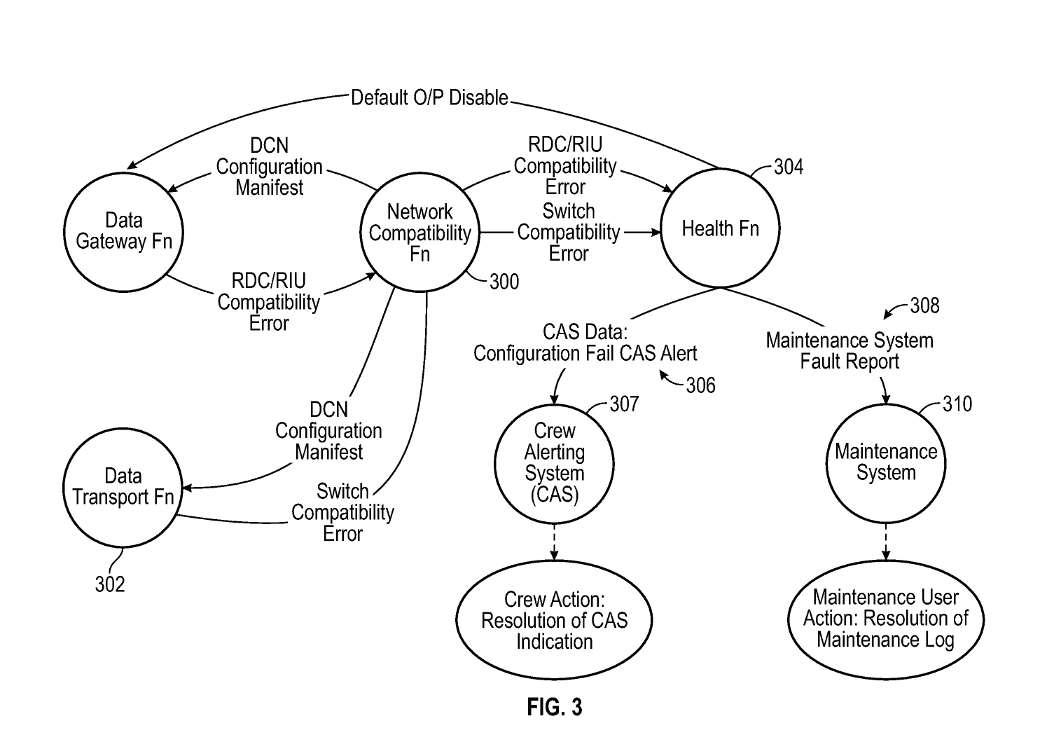

During initial startup of the aircraft, the configuration manifest 200 is loaded onto the DCN 100 as part of an initial dataload process. Referring now to FIG. 3, a Network Compatibility Function 300 running on the RDCs 102 that are electrically connected to the ground bus distribute the configuration manifest 200 to components on the DCN 100, e.g, A664 switches 104, other RDCs 102, using the Data Transport Function 302

The Network Compatibility Function 300 running on each component (e.g., the RDCs 102, the A664 switches 104, other LRUs, etc.) compares the current configuration of the DCN 100 to the configuration manifest 200. As each component has its part numbers stored in an internal memory (not shown), the Network Compatibility Function 300 on each component compares its own part number against the configuration manifest 200. If a component on the DCN 100 is found to be incompatible, e.g., not on the configuration manifest 200 or having a mis-matched part number, then the Network Compatibility Function 300 within that particular component reports the error to a Health Function 304. In response, the Health Function 304 generates a Configuration Fail CAS Alert message 306. In the exemplary embodiment, the Configuration Fail CAS Alert message is sent to a Crew Alerting System (“CAS”) 307, which includes a display (not shown) to alert the crew of the aircraft. The Health Function 304 also generates a Fault Report 308, which is sent to a maintenance system 310.

The Network Compatibility Function 300 also disables outputs of the RDC 102 if the part number of the RDC 102 and devices connected to the RDC 102 do not match the configuration manifest 200. The Network Compatibility Function 300 within the RDC 102 also checks the configuration of the RIU 106 connected to the RDC 102 against the configuration manifest 200. If the RIU 106 is out of configuration, i.e., if the part numbers do not match the configuration manifest 200, then the RDC 102 will (a) stop sending data to the RIU 106 and (b) record the status of all received data from the RIU 106 as non-deliverable (“ND”).

The Network Compatibility Function 300 will not disable the A664 switch. As such, the A664 switch 106 will continue to attempt to switch the traffic, i.e., route data, according to its incorrect, yet current state. It is assumed that a majority of incorrect A664 switch 106 installations will be a result of a similar A664 switch 106 of an older revision or different aircraft variant in which case a majority of the functionality of the A664 switch 106 would still operate correctly. The A664 switch 106 is an integral part of the communication path and therefore its continued operation in a failed configuration is beneficial in ground troubleshooting the maintenance messages. The Network Compatibility Function 300 will also place all electrical signals of the ESC and the IOGM in a default safe state if an incompatibility is detected.

FIG. 4 is a flow diagram illustrating a method 400 of determining compatibility in an aircraft communications network. In the example provided, network devices such as RDCs 102, MAUs 107, and RIUs 106 perform operations of method 400. For example, each network device may be loaded with software or firmware that instructs the network device to perform each operation of method 400, as will be appreciated by those with ordinary skill in the art.

The network device receives electrical power in operation 410. For example, when the aircraft is powering up prior to a flight, network devices may also power up and begin performing operations of method 400. Operation 412 determines whether a configuration manifest is stored on the network device. In the example provided, configuration manifest 200 is stored on two of the RDCs 102 and none of the other network devices. For example, configuration manifest 200 may be stored in software or firmware of the network device as part of the factory software or firmware installation by the manufacturer. It should be appreciated that the configuration manifest may be stored on more or fewer network devices without departing from the scope of the present disclosure. As described above, configuration manifest 200 describes the hardware and software profile of the network device. As used herein, the term “software” includes firmware and other programmable configurations.

When the network device does have the configuration manifest stored, the network device retrieves the manifest from storage in operation 414. For example, configuration manifest 200 may be retrieved from a memory component of the network device. Network device publishes the configuration manifest in operation 416. For example, an RDC 102 that stores configuration manifest 200 may distribute configuration manifest 200 across DCN 100 for use by other network devices. In some embodiments, the network device continues to publish the configuration manifest on a regular basis. For example, the network device may continue to publish configuration manifest 200 every second. Accordingly, devices that are newly added to DCN 100 may receive configuration manifest 200 and verify compatibility with DCN 100.

The network device compares the stored and retrieved configuration manifest against a hardware and software profile of the network device in operation 418. For example, a first of RDCs 102 may retrieve configuration manifest 200 from memory and compare the retrieved configuration manifest 200 against a first hardware and software profile of the first of the RDCs 102. In the example provided, the hardware and software profiles include the hardware and software part numbers of the network device as well as the hardware and software part numbers of each sensor, system, or component that utilizes the network device to communicate on DCN 100.

When the configuration manifest is not stored on the network device, the network device proceeds directly to operation 420 from operation 412. The network device receives the configuration manifest over the communications network in operation 420. For example, the first of the RDCs 102 may receive the configuration manifest from a second of the RDCs 102 that published the configuration manifest to a communications bus of DCN 100.

The network device compares the received manifest with a hardware and software profile that describes the network device and any devices using the network device to access the communications network in operation 422. For example, the first of the RDCs 102 may compare the configuration manifest received from the second of the RDCs 102 to the first hardware and software profile that describes the hardware and software part numbers of the first of the RDCs 102. In the example provided, the first of the RDCs 102 compares the stored configuration manifest 200 as well as the received configuration manifest 200 with the hardware and software profile of the first of the RDCs 102.

The network device determines whether the network device is compatible with the communications network in operation 424. For example, the first of the RDCs 102 may use the results of the comparison operation 422 and the network compatibility function 300 to determine whether the first of the RDCs 102 is compatible with DCN 100. When the network device is compatible with the communications network, the network device enables itself for normal operations in operation 426. For example, the first of the RDCs 102 may proceed with the intended function of the first of the RDCs 102 (e.g., collision avoidance when the first of the RDCs 102 is a collision avoidance system) with all outputs from the first of the RDCs 102 enabled on DCN 100.

When the network device is not compatible with the communications network, the network device generates a configuration failure alert on the communications network in operation 430. In the example provided, the configuration failure alert is a CAS message alerting the flight crew of the incompatibility, as will be appreciated by those with ordinary skill in the art. The network device then disables all output from the network device in operation 432.

The present invention has been described herein in an illustrative manner, and it is to be understood that the terminology which has been used is intended to be in the nature of words of description rather than of limitation. Many modifications and variations of the invention are possible in light of the above teachings.

The invention may be practiced otherwise than as specifically described within the scope of the appended claims.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. An aircraft communications network comprising:
a communications bus;
a first network device communicatively coupled with the communications bus, the first network device configured to publish on the communications bus a configuration manifest that describes a compatible configuration of hardware and software for the aircraft communications network; and
a second network device communicatively coupled with the communications bus, the second network device configured to:
receive the configuration manifest from the first network device over the communications bus;
compare the configuration manifest to a second hardware and software profile that describes the second network device; and
disable outputs of the second network device in response to detecting a difference between the configuration manifest and the second hardware and software profile.

2. The aircraft communications network of claim 1, wherein the second network device is further configured to determine that the second network device is incompatible with the aircraft communications network in response to detecting the difference between the configuration manifest and the second hardware and software profile.

3. The aircraft communications network of claim 2, wherein the second network device is further configured to generate a configuration failure alert on the communications bus in response to determining that the second network device is incompatible with the aircraft communications network.

4. The aircraft communications network of claim 1, further comprising a sensor communicatively coupled with the second network device, and wherein the second hardware and software profile describes both the second network device and the sensor.

5. The aircraft communications network of claim 1, wherein the first network device is further configured to store the configuration manifest.

6. The aircraft communications network of claim 5, wherein the second network device is further configured to store the configuration manifest.

7. The aircraft communications network of claim 6, wherein the first network device is further configured to:
receive the configuration manifest from the second network device across the communications bus;
compare the configuration manifest to a first hardware and software profile that describes the first network device; and
disable outputs of the first network device in response to the configuration manifest differing from the first hardware and software profile.

8. The aircraft communications network of claim 7, wherein the first network device is further configured to compare the configuration manifest stored on the first network device with the first hardware and software profile.

9. The aircraft communications network of claim 8, wherein the second network device is further configured to compare the configuration manifest stored on the second network device with the second hardware and software profile.

10. The aircraft communications network of claim 6, wherein the configuration manifest is stored solely on at least one of the first network device and the second network device.

11. A network device for an aircraft communications network, the network device comprising:
a computer hardware component including an input/output (I/O) portion configured for connecting to an aircraft communications bus; and
a software component loaded into the computer hardware component,
wherein the computer hardware component and the software component cooperate to configure the network device to:
receive a configuration manifest through the I/O portion;
compare the configuration manifest to a hardware and software profile that describes the computer hardware component and the software component; and
disable outputs from the network device through the I/O portion in response to detecting that the configuration manifest differs from the hardware and software profile.

12. The network device of claim 11, wherein the network device is further configured to determine that the network device is incompatible with the aircraft communications network in response to detecting that the configuration manifest differs from the hardware and software profile.

13. The network device of claim 12, wherein the network device is further configured to generate a configuration failure alert at the I/O portion in response to determining that the network device is incompatible with the aircraft communications network.

14. The network device of claim 11, wherein the computer hardware component further includes a sensor input portion, and wherein hardware and software profile describes a sensor coupled with the sensor input portion, the computer hardware component, and the software component.

15. The network device of claim 11, wherein the network device is further configured to store the configuration manifest and to publish the configuration manifest at the I/O portion.

16. A method of determining compatibility of a network device with an aircraft communications network, the method comprising:
publishing on a communications network, by a first network device, a configuration manifest that describes a compatible configuration of hardware and software for the aircraft communications network;
receiving, at a second network device, the configuration manifest; and
comparing, at the second network device, the configuration manifest to a second hardware and software profile that describes the second network device.

17. The method of claim 16, further comprising disabling outputs of the second network device in response to determining that the configuration manifest differs from the second hardware and software profile.

18. The method of claim 16, further comprising generating a configuration failure alert on the aircraft communications network in response to determining that the configuration manifest differs from the second hardware and software profile.

19. The method of claim 16, further comprising retrieving the configuration manifest from an electronic storage device on the first network device.

20. The method of claim 16, further comprising:
retrieving the configuration manifest from an electronic storage device on the second network device;
publishing on the communications network, by the second network device, the configuration manifest;
receiving, at the first network device, the configuration manifest; and
comparing, at the first network device, the configuration manifest with a first hardware and software profile that describes the first network device.
